(19) United States
(12) Patent Application Publication
(10) Pub. No.: US 2016/0247046 A1
(43) Pub. Date: Aug. 25, 2016

(54) ROCKING PUSH-PUSH ACTIVATION DEVICE FOR A PUSH-PUSH CARD READER

(71) Applicant: AMPHENOL-TUCHEL ELECTRONICS GMBH, Heilbronn (DE)

(72) Inventors: Eckhard SCHEWE, Heilbronn (DE); Thomas SCHNELL, Heilbronn (DE)

(21) Appl. No.: 14/380,458

(22) PCT Filed: Apr. 30, 2014
(86) PCT No.: PCT/DE2014/100149

§ 371 Date: Aug. 22, 2014

(30) Foreign Application Priority Data
Apr. 16, 2014 (DE) 10 2014 105 435.0

(51) Int. Cl. G06K 13/08; G06K 7/00

(52) U.S. Cl. CPC G06K 13/0825; G06K 7/0069

(57) ABSTRACT

The invention relates to a push-push activation device for removing a card holding drawer from a housing of an apparatus, which push-push activation device has the following:
a) an activation element which is arranged on the card holding drawer so as to be slideable from an insertion position into a removal position, wherein
b) the activation element has an elastically deformable activation limb which has transversely with respect to the insertion direction S of the card holding drawer, and
c) the activation element can be activated from its insertion position into its removal position by means of a simultaneous two-point activation at two activation sections, spaced apart from one another, of the activation limb.

The present invention relates to an activation device for a push-push card reader as claimed in claim 1, and to a push-push card reader having an activation device as claimed in claim 8.

The present invention relates, in particular, to a rocking activation device for a card reader according to the push-push principle, in which a slider is placed in a position of rest, corresponding to the reading position of the card, with a first push on a card holding drawer, and with a second push the card holding drawer moves out of its removal position again.

The card types to which the present card readers relate are smartcards, micro-SD cards and other cards which are usually provided in card readers.

The present invention is therefore suitable for all types of drawers which can be activated for the purpose of holding cards.

Push-push readers usually have a control cam, in particular a cardioid control cam, which permits the cards to be secured in the reading position after a first push and to latch the corresponding card holding drawer, in order to leave the latter again after a further push, and finally to move it into a non-reading position in which the card can be removed from the reader.

Generally, push-push card readers, which are subject to continuous miniaturization especially for small card types such as, for example, micro-SD cards or transflash cards whose card size is smaller than SIM cards or micro-memory cards.

EP 0 833 268 A2 discloses a card reading device with a mechanism for releasing a card carrier.

In addition, U.S. Pat. No. 6,948,956 B2 discloses what is referred to as a push-push card reader which is equipped with two recesses for the parallel activation of a module.

Furthermore, document DE 10 2007 024 714 A1 discloses a device for holding a SIM card which has a push-push mechanism and a rocker.

For example, EP 2 131 305 A2 presents a push-push card reader which has a control cam duct and a control element which is connected to a spring element and forms what is referred to as a push-push mechanism.

The push-push mechanism which is shown in said document permits the control cam duct to be embodied with just two differences in height between the contact carrier floor, and therefore to achieve a significantly lower overall height. In addition it is possible to install such a card reader in an upside down position, which prevents the card from falling out.

However, this increasing miniaturization results in the problem of the activation of such push-push card readers or the activation of holding drawers into and out of such push-push card readers.

On the one hand, there is the problem that by carrying out a first push the card holding drawer can be unintentionally removed from the card reader and, on the other hand, the loss of the card holding drawer cannot be readily prevented. For this purpose, in the prior art embodiments are known in which an activation device which can be activated only by means of a tool is located on the push-push card reader.

For example, in the prior art a push-push card contacting device is thus known in which an opening is provided on the end side, specifically on the insertion-side end side of the card holding drawer, through which opening the activation device can be released, that is to say can be activated, with a sharp object. For example, the activation device can be actuated through the opening with a bent paperclip and in this way the card holding drawer can be unlocked from its latched reading position.

A disadvantage with such embodiments is that in each case the user has to have a particular tool or an object to hand in order, where appropriate, to open the push-push card reader in order to insert a card or remove the card.

A disadvantage with the miniaturized push-push card readers which are known in the prior art is therefore that no simple way of removing the card holding drawer is made possible.

On the other hand, the disadvantage with push-push card holding drawers which can be activated without a tool is that the drawer can be unintentionally released by pressing on the end side of the card holding drawer. This can also occur when using an apparatus in which a push-push card reading device is installed if the apparatus is carried in a pocket, for example a trouser pocket, or if it unintentionally impacts laterally against another object. In such cases, the card holding drawer is unintentionally released and the card holding drawer can be lost and an unintentional data loss can occur.

A quite significant further disadvantage is, however, also that in the case of conventional card reading devices the card holding drawer is always activated out of its reading position (insertion position) by any activation process, and therefore even in the case of an unintentional activation. In order to prevent this further, additional protective measures are necessary.

The object of the present invention is therefore to provide an activation device for the targeted release of a card holding drawer of a push-push card reader, in which, on the one hand, it is possible to perform activation without a tool, i.e. manually, and, on the other hand, unintentional, i.e. inadvertent, triggering of the card holding drawer is selectively prevented or, at any rate, made more difficult to the extent that a reading process is not unintentionally interrupted.

This object is achieved with an activation device having the features of claim 1.

The basic concept of the present invention is to provide an activation device with a special activation mechanism with which it is possible to move the activation mechanism as such relatively with respect to a card holding drawer and at the same time the activation device has activation sections, and the activation element is successfully released only if a targeted two-point activation takes place correctly at two activation sections of the activation element which are spaced apart from one another.

This is done by decoupling the primary locking of the card holding drawer from the unlocking, i.e. the release process of an activation means (secondary locking) which is displaceably attached to the card holding drawer and can be moved from its locked insertion position into its removal position.

In this way, firstly by activating the activation element a relative movement of the activation element with respect to the card holding drawer can be achieved, which means that the activation element then protrudes with respect to the housing of a device into which the card holding device is inserted and secured (i.e. after activation), in order to then grasp the drawer manually and remove the entire card holding drawer from its reading position.

Even in the case of an, under certain circumstances, improbable unintentional activation of the previously described two-point activation of the activation element, although the activation element is therefore released from its insertion position into the removal position and will therefore protrude with respect to the housing of an apparatus, it can, however, be pressed back into its original insertion position again in order to avoid interruption of contact as a result of the removal of the card drawer.

According to the invention, a push-push activation device for removing a card holding drawer from a housing of an apparatus is proposed, which push-push activation device has the following:
an activation element which is arranged on the card holding drawer so as to be slideable from an insertion position into a removal position, wherein
the activation element has an elastically deformable activation limb which has transversely with respect to the insertion direction S of the card holding drawer, and
the activation element can be activated from its insertion position into its removal position by means of a simultaneous two-point activation at two activation sections, spaced apart from one another, of the activation limb.

In one particularly preferred embodiment of the invention, the activation element is mounted on bearing means on a securing section which protrudes from the end side (i.e. from the insertion side) of the card holding drawer or a securing section which is formed by the card holding drawer.

In other words, the card holding drawer has a securing section in order to mount the activation element movably thereon.

It is also advantageously provided that the activation element has at least one bearing web which runs in the insertion direction and along which the activation element is guided. The different movement possibilities of the activation element can be implemented by means of such a bearing web, preferably by means of four bearing webs and particularly preferably by means of five bearing webs. On the one hand, in this case two bearing webs can be arranged in each case in pairs one on top of the other (in a slidingly movable fashion) on the one side of the securing section of the card holding drawer, while a fifth bearing web, as specified above, is arranged on an opposite side of the securing section. This results in targeted engagement of the activation element about the securing section.

It is also advantageous if the activation element is embodied as a substantially T-shaped stamped/bent part which has four bearing webs on the one side and a fifth bearing web on the other side, wherein the bearing webs each extend in the insertion direction and are embodied in one piece with the activation limb.

It is also advantageous if the activation element is embodied as a complex stamped/bent part, wherein two of the bearing webs are embodied in a first plane, and these are subsequently connected at the end side to the activation limb, and bending around further a U-shaped bar adjoins the activation limb.

In a further preferred embodiment of the invention, a bearing means of the securing section is embodied as a cardioid control cam arrangement with at least one locking section in a side face of the securing section.

It is particularly advantageous if the activation means is coupled via a coupling arm, for example a wire spring element, to the cardioid control cam arrangement in which one end of the coupling arm engages in the control cam of the cardioid control cam arrangement. This means that in the case of a two-point activation of the push-push activation device, as previously described, the coupling arm is released from a locking position with its locking section and is moved along the control cam to a securing section at which the activation element is secured in a removal position. In the case of a second push for inserting the activation element into its original insertion position, the coupling arm is forcibly guided in the control cam, specifically back into its original locking position.

In a further advantageous embodiment of the present invention, in each case two bearing webs which are arranged one above the other interact with in each case one common bearing means.

According to the invention there is provision that the activation element is supported on the card holding drawer so as to rock about a central bearing means, specifically counter to the spring force of springs (compression springs).

The springs are preferably arranged between end-side receptacles of the securing section on the card holding drawer and corresponding receptacles on the activation element, preferably in the region of the U-shaped bar. In this way, in the case of pressure on a lateral activation section of the activation element, that is to say of the activation limb of the activation element, the activation element can be turned or rocked about the bearing means through a certain angle, wherein the activation element is simultaneously elastically deformed out of its original shape.

It is also preferred if the activation element is actuated by means of a targeted simultaneous two-point activation on the two activation sections, spaced apart from one another, of the activation limb, and the latter can be activated in its removal position out of its insertion position in which the control bar is, as explained above, in engagement with the locking section of the cardioid control cam arrangement. In the case of this two-point activation, the activation limb deforms in an arcuate shape, while the bar of the activation element remains substantially rigid.

If, on the other hand, the activation element is activated in the case of a single-point activation on one of the activation sections, a rocking movement about the bearing means occurs, with the result that the activation element also deforms at least partially elastically, preferably in the region of the activation limb, and the activation element carries out a rocking or rotating movement.

There is therefore advantageously provision that the activation element has a central stop, preferably a stop provided at the top and bottom of the activation limb as tongues, in order to form an abutment for the housing. As a result of this abutment, the central section of the activation element cannot be moved with respect to the housing in the case of pressure acting on the activation limb in the region of the stop or in the case of off-center activation or even in the case of a two-point activation.

On the other hand, as a result of the elasticity of the activation element which is embodied as a stamped/bent part it is possible to deform elastically the lateral areas of the activation limb which are not supported against the housing by the stop, and to insert a piece far against the springs into the housing receptacle. As a result, the one (lower) bearing web which is in operative engagement with the cardioid cam arrangement will be activated and the activation element triggered in its entirety from its insertion position.

In an embodiment of the invention which is therefore particularly preferred, the activation element is of symmetrical design with the result that the said stop is arranged centrally between the first (lateral) activation section and the second (lateral) activation section of the activation limb of the activation element.

In a further preferred embodiment of the invention, the activation element also has two switching arms in order, in the case of a rocking movement of the activation element, optionally to trigger a switching process with respect to switches which are arranged in the housing either with the one switching arm or with the other switching arm.

For this purpose, the switching arms are advantageously each arranged laterally on one of the bearing webs, with the result that in the case of an activation of the activation limb the switching arm which lies respectively diagonally opposite is displaced laterally on just one activation section and can trigger the previously described switching process.

Combinations and alternatives of the embodiment described above are also the subject matter of the present invention. In addition it is to be noted that the exemplary embodiment specified below is not restrictive but rather is only exemplary for the description of the present invention.

Further details of the invention can be found in the description of the exemplary embodiment with reference to drawings in which:

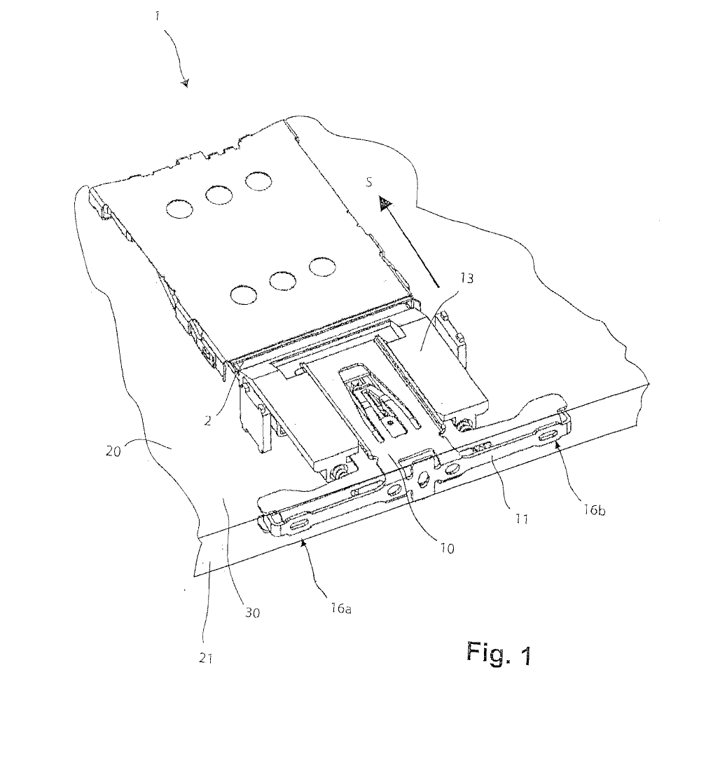

FIG. 1 shows a perspective view of a first exemplary embodiment of a push-push activation device according to the invention;

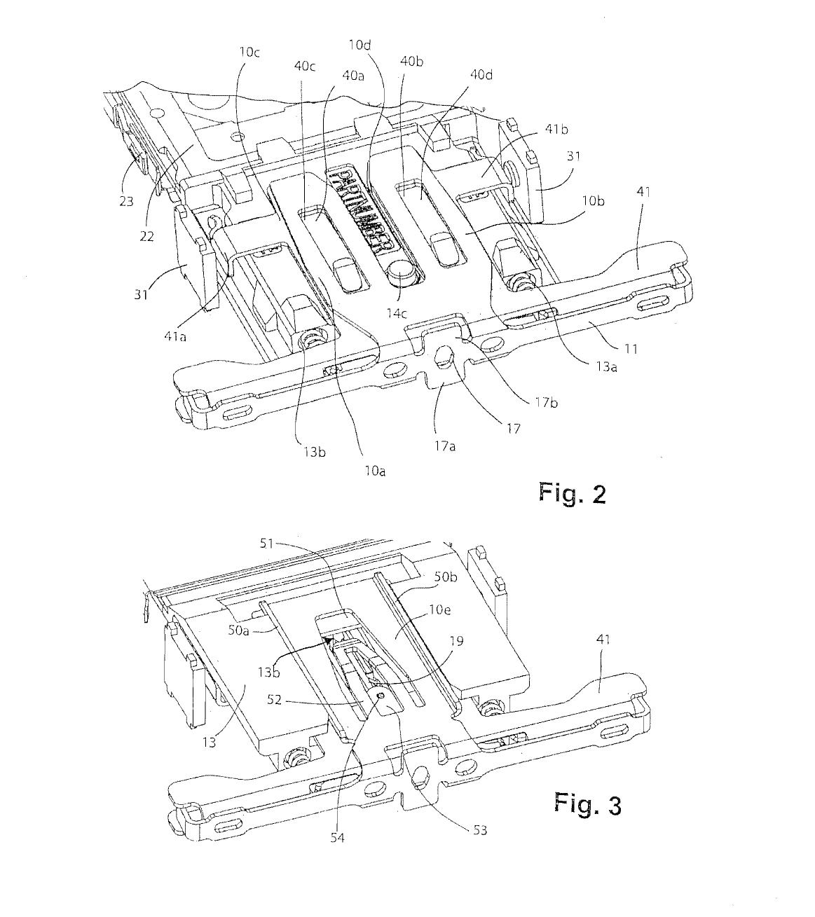

FIG. 2 shows a perspective view, similar to FIG. 1, from the opposite perspective;

FIG. 3 shows a perspective view of a detail, from FIG. 1;

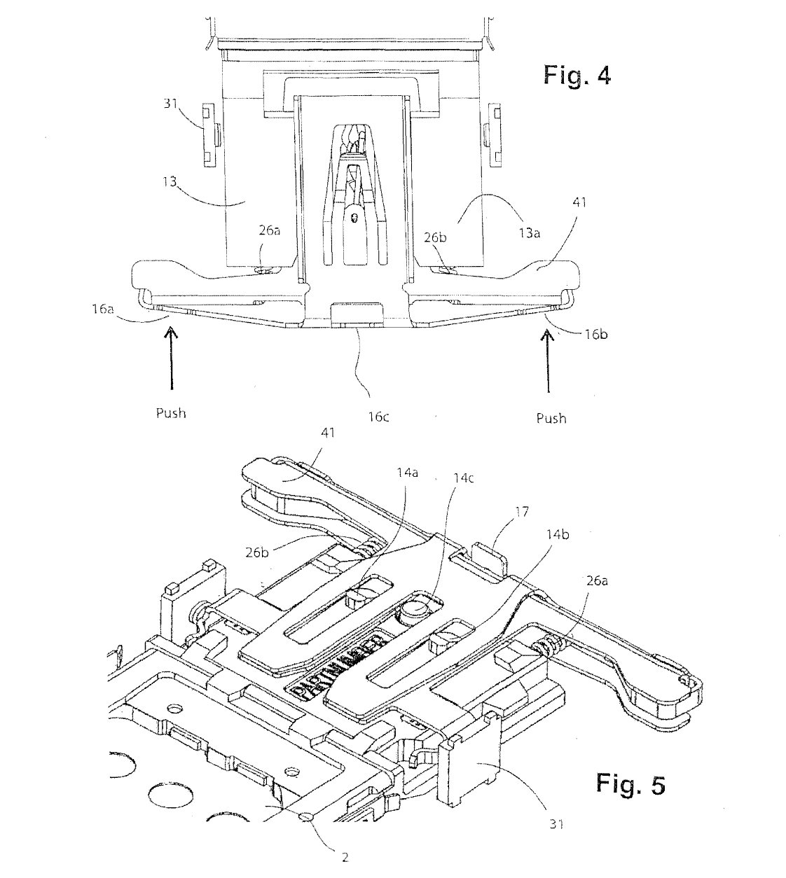

FIG. 4 shows a plan view, similar to FIG. 3, in a partially activated position of the activation element;

FIG. 5 shows a perspective view, similar to FIG. 2, in a view from obliquely from the rear;

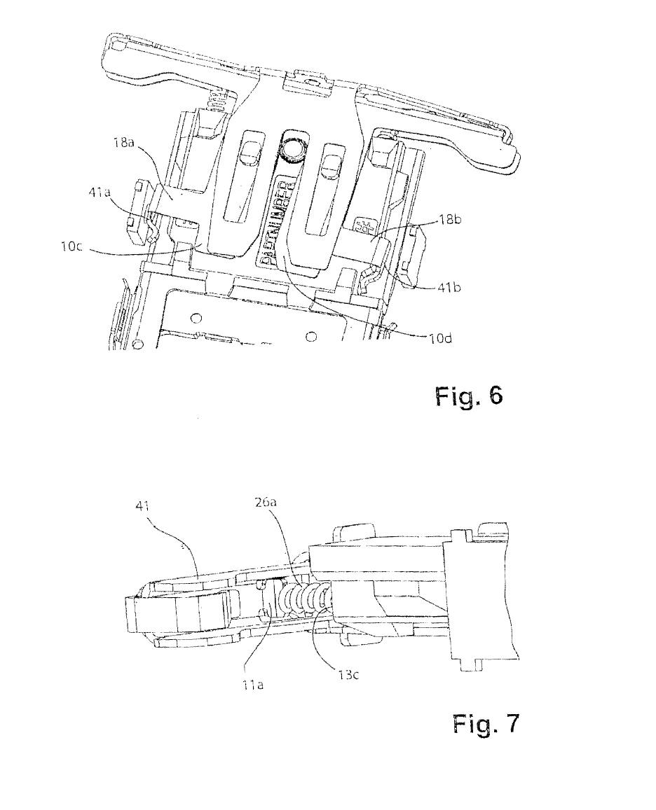

FIG. 6 shows a view, similar to FIG. 5, in which the activation element experiences a single-point activation on the activation section; and

FIG. 7 shows a view of a detail of a lateral section of the activation element.

FIG. 1 shows an exemplary embodiment of a push-push activation device 1.

The push-push activation device 1 comprises a card holding drawer 2 which is inserted into a housing 20 of an apparatus 30 (illustrated by way of example), wherein in the completely inserted state the end side of the activation element 10, specifically the end side of the activation limb 11, terminates flush with the front 21 of the housing 20.

Part of the card holding drawer 2 can be seen in more detail in FIG. 2. The card holding drawer 2 has a receptacle 22 for inserting a card into the card holding drawer 2. The card holding drawer 2 also has spring elements 23 with which it can be locked in a sprung fashion into a reading position at corresponding latching geometries in the housing 20 of the apparatus 30.

In the reading position of the card holding drawer 2 and the insertion position of the activation element 10, the end side of the activation element 10 terminates flush with the front 21 of the housing, as stated above.

This can also be brought about by fitting a cover element onto the front activation limb 11 of the activation element 10, and by selecting the position of the push-push activation device 1 in the housing 20 such that the latter terminates flush with the front 21 of the housing.

The activation element 10 is described below. The activation element 10 is preferably embodied as a multiply shaped stamped/bent part composed of an elastic spring material. The activation element 10 has in its first plane two bearing webs 10a, 10b which are connected to the front activation limb 11 and each have an elongate bearing guide opening 40a, 40b.

The activation limb 11, which runs transversely with respect to the insertion direction S as an elastic spring limb on the end side, terminates on the end side in each case against a bar or bar section 41 which is bent over in a substantially U shape. A further two bearing limbs 10c, 10d (see in this respect also FIG. 6) extend from the bar 41 directly underneath the previously mentioned bearing webs 10a, 10b in the same direction, specifically in the insertion direction S.

The two bearing webs 10c, 10d also have bearing guide openings 40c, 40d. The bearing webs 10c, 10d are arranged directly in the plane underneath the bearing webs 10a, 10b in contact with the latter.

A switching arm 18a or 18b adjoins each of the bearing webs 10c, 10d laterally. Each of the switching arms 18a, 18b has a contact point 41a or 41b in order to interact with a switch 31 which is provided in the housing 20, or to trigger a switching process of this switch as a result of a rocking rotational movement of the activation element 10.

The bottom view of the push-push activation device 1 is shown in a detailed view in FIG. 3.

Firstly, the bottom view of the activation element 10 will be described further. The activation element 10 has a further bearing web 10e. The bearing web 10e has lateral bending sections 50a and 50b which extend in the plug-in direction S along the edges of the bearing web 10. In the central region of the bearing web 10, an opening 51 is formed, wherein a spring bar 52 extends into the opening 51. In the base region of the spring bar, specifically in the connecting region of the bearing web 10e, a lip 53 is formed on the activation limb 11 or in the prolongation thereof. A securing element 54, into which the one end of a coupling arm 19 is inserted, is located in the lip 53. Via this coupling arm 19, the activation means 10 is with the cardioid cam arrangement 13b, explained later below, in the securing section 13 of the push-push activation device 1.

A securing section 13 adjoins, at the end side, the card holding drawer 2 described above, or the card holding drawer 2 forms said securing section 13. Bearing means 14a, 14b and 14c are, as shown in FIG. 5, provided on the securing section 13, and the bearing means 14d, which are formed on the opposite side in the side face 13a of the securing section 13, as can be seen in FIG. 4. The activation element 10 can still execute the movement possibilities (described in more detail below) along the bearing means.

FIG. 4 shows how, by means of a two-point activation onto the activation sections 16a and 16b which are activated simultaneously, the activation element 10 is firstly moved in the insertion direction S in that the activation limb 11 bends somewhat in an arcuate shape, while the U-shaped bar 41 remains substantially dimensionally stable. This is done in that the stop 17 which is illustrated in FIG. 2 is supported against a corresponding abutment on the housing 20. This prevents the central section 16c of the activation limb 11 from being activated in the insertion direction S but instead the latter remains supported firmly against the housing 20.

As a result of the activation of the activation element 10, the latter is firstly moved, controlled via the cardioid cam arrangement 13b, out of its insertion position for a certain distance out of its locking position, as a result of which the coupling arm 19 is released with its coupling arm end 19a in the control cam of the cardioid control cam arrangement 13b out of its locking position in such a way that when the activation means 10 is released the latter is slid counter to the insertion direction S from its original insertion position into a removal position, specifically conditioned by the springs 26a, 26b.

The springs 26a, 26b are as is clearly apparent from FIGS. 4 and 7, mounted on an inner securing device 11a in the U-shaped bar section 41, while the other end of the springs 26a, 26b engages in a receptacle opening 13c. As a result, a rocking movement about the bearing means 14b is possible, wherein the central section 16c remains in each case in its position supported against the housing. Such a rocking movement is indicated by way of example in FIG. 6. Here, the activation section 16a is acted on with a single-point activation, as a result of which the activation element 10 is inserted on one side into the housing (not illustrated here), and the activation limb 11 is deformed in such a way that although the upper bearing webs 10a, 10b remain in a virtually non-displaced position, at any rate they are twisted only slightly, while the lower bearing webs 10c, 10d execute a compensating lateral movement and as a result actuate or activate one of the switches 31.

In the widest sense, the activation element 10 can be referred to as a T-shaped activation element 10. As already described above, in each case two bearing webs 10a, 10c or the bearing webs 10b, 10d which are mounted one on top of the other will interact with in each case one common bearing means 14a or 14b. The bearing means 14c is advantageously formed as a bearing pin which protrudes in the same direction from the securing section 13 as the bearing means 14a and 14b which are formed substantially in a ramp shape.

Since the activation element 10 is supported against the springs 26a, 26b on the end side of the securing section of the card holding drawer 2, the activation element 10 can move in a rocking fashion about the bearing means 14b.

Since the activation element 10 is also movably mounted, by means of a control bar, on the bearing means 14c which are embodied as a cardioid cam, by means of a simultaneous two-point activation on the two activation sections 16a, 16b which are spaced apart from one another and which are arranged laterally next to the central section 16c, can be activated out of an insertion position in which the control bar is in engagement with the locking section of the cardioid control cam arrangement.

In the case of a single-point activation on one of the activation sections 16a or 16b, the activation element 10 carries out to this effect a rocking movement about the bearing means 14b, and the activation element 10 deforms at least partially in a sprung elastic fashion. In the case of a single-point activation on the central section 16c on which the stop 17 is arranged, the activation element 10 leads to this effect cannot experience any translatory displacement. The stop 17 is preferably constructed from two tabs 17a, 17b which are formed in a manner protruding in the vertical direction (upward and downward) from the activation limb 11. A corresponding abutment is located on the housing 2, but it has not been explicitly illustrated in the figures.

### LIST OF REFERENCE SYMBOLS

1 Push-push activation device

2 Card holding drawer

10 Activation element

10a, 10b Bearing webs

10c, 10d Bearing webs

10e Bearing web

11 Activation limb

11a, 11b Securing device

13 Securing section

13a Side face

13b Cardioid cam arrangement

13c, 13d Receptacle opening

14a, 14b, 14c, 14d Bearing means

15 Control bar

16a, 16b Activation sections

16c Central section

17 Stop

17a, 17b Tabs

18a, 18b Switching arm

19 Coupling arm

19a Coupling arm end

20 Housing

21 Housing front

22 Receptacle

23 Spring elements

26a, 26b Springs

30 Apparatus

31 Switch

40a, 40b Bearing guide openings

40c, 40d Bearing guide openings

41a, 41b Contact points

50a, 50b Bending sections

51 Opening

52 Spring bar

53 Tab

54 Securing element

S Insertion direction/plug-in direction

1. A push-push activation device for removing a card holding drawer from a housing of an apparatus, which push-push activation device has the following:
a) an activation element which is arranged on the card holding drawer so as to be slideable from an insertion position into a removal position, wherein
b) the activation element has an elastically deformable activation limb which has transversely with respect to the insertion direction (S) of the card holding drawer, and
c) the activation element can be activated from its insertion position into its removal position by means of a simultaneous two-point activation at two activation sections, spaced apart from one another, of the activation limb.

2. The push-push activation device as claimed in claim 1, wherein the activation element is mounted on bearing means on a securing section which protrudes from the end side of the card holding drawer.

3. The push-push activation device as claimed in claim 1, wherein the activation element has at least one bearing web which runs in the insertion direction (S) and along which the activation element is guided.

4. The push-push activation device as claimed in claim 3, wherein the activation element constitutes a T-shaped stamped bent part which has four bearing webs, wherein in each case two bearing webs are arranged in contact one above the other.

5. The push-push activation device as claimed in claim 2, wherein a bearing means is embodied as a cardioid control cam arrangement with at least locking section in a first side face of the securing section.

6. The push-push activation device as claimed in claim 4, wherein the in each case two bearing webs and which are arranged one above the other, respectively, interact with in each case one common bearing means.

7. The push-push activation device as claimed in claim 1, wherein the activation element is supported on the card holding drawer so as to rock about the bearing means counter to the springs.

8. The push-push activation device as claimed in claim 3, wherein the activation element is movably mounted by means of a control bar on the bearing means which are embodied as a cardioid cam and can be activated into its removal position by a simultaneous two-point activation on the two activation sections, spaced apart from one another, of the activation limb, from its insertion position in which the control bar is in engagement with the locking section of the cardioid control cam arrangement.

9. The push-push activation device as claimed in claim 8, wherein in the case of a single-point activation on one of the activation sections the activation element carries out a rocking movement about the bearing means, and the activation element deforms at least partially elastically.

10. The push-push activation device as claimed in claim 1, wherein the activation element has a central stop for the purpose abutting against the housing.

11. The push-push activation device as claimed in claim 10, characterized in that wherein the stop is arranged at the end side between the first lateral activation section and the second lateral activation section of the activation element.

12. The push-push activation device as claimed in claim 1, wherein the activation element also has two switching arms in order, in the case of a rocking movement, optionally to trigger a switching process either with the one switching arm or with the other switching arm.

13. The push-push activation device as claimed in claim 5, wherein the activation means couples to the cardioid control cam arrangement via a coupling arm in that one end of the coupling arm engages in the control cam of the cardioid control cam arrangement.
